(19) United States
(12) Patent Application Publication
(10) Pub. No.: US 2015/0272182 A1
(43) Pub. Date: Oct. 1, 2015

(54) Vegetable Chip Spread

(71) Applicant: Joseph C. Coffey, Staten Island, NY (US)

(72) Inventor: Joseph C. Coffey, Staten Island, NY (US)

(21) Appl. No.: 14/635,433

(22) Filed: Mar. 2, 2015

Related U.S. Application Data
(60) Provisional application No. 61/973,165, filed on Mar. 31, 2014.

(51) Int. Cl. A23L 1/221

(52) U.S. Cl. CPC A23L 1/221

(57) ABSTRACT

Disclosed is a vegetable chip spread comprising cooked vegetable chips and added oil, wherein the cooked vegetable chips have limited size dimensions, and wherein the vegetable chip spread has an oil content ranging from about 40% to about 70%, by weight.

### CROSS REFERENCE TO RELATED APPLICATION

This application claims priority to U.S. Provisional Patent Application No. 61/973,165 filed on Mar. 31, 2014, which is incorporated by reference herein.

### BACKGROUND

Vegetable chips are often consumed as a side-dish accompanying an entrée such as a sandwich or hamburger. Potato chips, for example, are often served with sandwiches at, for example, lunch or dinner. In fact, the taste of a vegetable chip complements the taste of a sandwich so well that people often insert the vegetable chip into the body of the sandwich so that the sandwich and chip may be consumed simultaneously. This practice has led to the development of vegetable chip products for use as a garnish for sandwiches. For example, U.S. Pat. No. 8,357,409 describes a crispy chip product that is formed in the shape of a slice of bread and intended to be placed between the two slices of bread that typically comprise the outermost layers of a sandwich. One problem with using a crispy chip as a sandwich garnish, however, is that when one bites the sandwich, the crispy chip fractures, leaving chip fragments free to drop out of from between the slices of bread used in the sandwich. Another problem with a crispy chip as a sandwich garnish is that the shape of the garnish will not match or compliment the shape of every type of bread one might wish to use in making the sandwich. A need exists, therefore, for a product that provides a convenient way to impart the taste of the vegetable chip to a sandwich without the problems of chip fragmentation and lack of matching or complimentary shape.

### SUMMARY

The present invention is directed to a vegetable chip spread that satisfies the need for a convenient way to impart the taste of a vegetable chip to a sandwich without the problems of chip fragmentation and lack of matching or complimentary shape. A vegetable chip spread having features of the claimed invention comprises cooked vegetable matter and added oil, wherein the oil content of said vegetable chip spread is from about 40% to about 70%, by weight. In particular, a vegetable chip spread having features of the claimed invention comprises cooked vegetable chips, wherein substantially all of the vegetable chips have no single dimension greater than 1 cm in length; and oil, wherein the oil content of said vegetable chip spread is from about 40% to about 70%, by weight. A vegetable chip spread having features of the claimed invention solves the problems of chip fragmentation and lack of matching or complementary shape.

These and other features, aspects, and advantages of the present invention will become better understood with regard to the following description and claims.

### DETAILED DESCRIPTION

As used herein, the term “vegetable chip” refers to a crispy, cooked chip comprising vegetable matter. Cooked vegetable chips are well known, commercial commodities that are sold under various trade names, such as Lay's®, Ruffles®, Pringles®, Utz®, Kettle® Brand, Cape Cod® Potato Chips, Herr's®, Wise®, Terra Chips®, Popchips®, Golden Flake®, Fritos®, and Doritos®. Vegetable chips may be made from a raw vegetable by cutting the vegetable into thin cross-sectional slices, and then either baking the slices or deep frying the slices in oil. For example, a potato chip may be made by cutting slices of potatoes and then deep frying the slices in oil until they are crispy. The methods of preparing cooked vegetable chips are well known in the art. Vegetable chip spreads embodying features of the present invention may be made using any commercially available vegetable chip or a vegetable chip made for use in a vegetable chip spread.

The vegetable chip used in a vegetable chip spread that embodies the present invention may be made from any edible vegetable, including, but not limited to, potato, corn, sweet potato, zucchini, turnip, squash, beet, eggplant, bell pepper, yucca, parsnip, taro, batata, carrots, and onion. Preferred vegetable chips for use in a vegetable chip spread are potato chips and corn chips.

As used herein, the term “oil” refers to any edible oil. Many such oils are commercially available. The oil used in a vegetable spread that embodies the present invention may be any oil suitable for use in a food product including, but not limited to, almond oil, avocado oil, canola oil, cashew nut oil, castor oil, chia oil, coconut oil, corn oil, flaxseed oil, melon seed oil, mustardseed oil, olive oil, palm oil, peanut oil, safflower oil, sesame oil, soybean oil, sunflower oil, and vegetable oil. Preferred oils for use in the present invention are canola oil, corn oil, olive oil, peanut oil, safflower oil, sunflower oil, and vegetable oil. More preferred oils for use in the present invention are canola oil, corn oil, and sunflower oil.

As used herein, the term “added oil” refers to one or more oils that are added to the cooked vegetable chips to prepare the vegetable chip spread. “Added oil” is thereby distinguished from oil that is already present in the cooked vegetable chips, i.e., oil (including fat) that is naturally in the vegetable or is present in the cooked vegetable chip as a consequence of the cooking process. As used herein, the term “total weight of oil” refers to the combined weight of the added oil and any oil already present in the cooked vegetable chips.

The term “oil content” refers to the percentage of the weight of the vegetable chip spread contributed by the total weight of oil. An oil content in the range of from about 40% to about 70% results in a vegetable chip spread of suitable consistency and viscosity. Oil content less than about 40% results in a product that is too viscous; oil content greater than about 70% results in a product that is insufficiently viscous and prone to physical separation of the vegetable matter and the oil upon standing. The optimum oil content for a specific embodiment will depend upon the type of vegetable chip (or chips) being used and the identity of the oil or oils. Generally speaking, however, an oil content in the range of from about 45% to about 55% is preferred.

A vegetable chip spread embodying the features of the claimed invention comprises: (1) cooked vegetable chips, wherein substantially all of said cooked vegetable chips have no single dimension greater than 1 cm in length; and (2) added oil, wherein the oil content of said vegetable chip spread is from about 40% to about 70%. As used herein, the term “substantially all of the cooked vegetable chips” means at least 85% of the number of cooked vegetable chips.

For a potato chip spread embodying the features of the present invention, an oil content of from about 50% to about 60% is most preferred. For a corn chip (including tortilla chips—a type of corn chip) spread embodying the features of the present invention, an oil content of from about 42% to about 50% is most preferred.

Thus, in one embodiment, the vegetable chip spread comprises: (1) cooked vegetable chips; and (2) added oil, wherein the oil content of said vegetable chip spread is from about 40% to about 70%. In a preferred embodiment, the vegetable chip spread comprises: (1) cooked vegetable chips; and (2) added oil, wherein the oil content of said vegetable chip spread is from about 42% to about 50%. In another preferred embodiment, the vegetable chip spread comprises: (1) cooked vegetable chips; and (2) added oil, wherein the oil content of said vegetable chip spread is from about 50% to about 60%. In another preferred embodiment, the vegetable chip spread comprises: (1) cooked vegetable chips; and (2) added oil, wherein the oil content of said vegetable chip spread is from about 51% to about 53%. In another preferred embodiment, the vegetable chip spread comprises: (1) cooked vegetable chips; and (2) added oil, wherein the oil content of said vegetable chip spread is from about 45% to about 48%. In another more preferred embodiment, the vegetable chip spread comprises: (1) cooked potato chips; and (2) added oil, wherein the oil content of said vegetable chip spread is from about 51% to about 53%. In another more preferred embodiment, the vegetable chip spread comprises: (1) cooked corn chips; and (2) added oil, wherein the oil content of said vegetable chip spread is from about 45% to about 48%.

A vegetable chip spread embodying the features of the present invention may also comprise more than one type of vegetable chip (i.e., vegetable chips made from more than one species of vegetable). Thus, in one embodiment, the vegetable chip spread comprises: (1) a first type of cooked vegetable chip; (2) a second type of cooked vegetable chip; and (3) added oil, wherein the oil content of said vegetable chip spread is from about 40% to about 70%. In another embodiment, the vegetable chip spread comprises: (1) a first type of cooked vegetable chip; (2) a second type of cooked vegetable chip; and (3) added oil, wherein the oil content of said vegetable chip spread is from about 42% to about 50%. In another embodiment, the vegetable chip spread comprises: (1) a first type of cooked vegetable chip; (2) a second type of cooked vegetable chip; and (3) added oil, wherein the oil content of said vegetable chip spread is from about 50% to about 60%. In another embodiment, the vegetable chip spread comprises: (1) a first type of cooked vegetable chip; (2) a second type of cooked vegetable chip; and (3) added oil, wherein the oil content of said vegetable chip spread is from about 51% to about 53%. In another embodiment, the vegetable chip spread comprises: (1) a first type of cooked vegetable chip; (2) a second type of cooked vegetable chip; and (3) added oil, wherein the oil content of said vegetable chip spread is from about 45% to about 48%.

A vegetable chip spread embodying the features of the present invention comprises cooked vegetable chips wherein substantially all of the cooked vegetable chips have no single dimension greater than 1 cm in length, preferably have no single dimension greater than 0.75 cm in length, and more preferably have no single dimension greater than 0.5 cm in length. Limiting the dimensions of the cooked vegetable chips to those having no single dimension greater than 1 cm ensures that the vegetable chip spread containing the cooked vegetable chips will have a uniform consistency and be spreadable. Most commercially available vegetable chips have at least one dimension considerably larger than 1 cm. Similarly, most methods of making vegetable chips results in chips the majority of which have at least one dimension considerably larger than 1 cm. As a result, processes for making vegetable chip spreads embodying the features of the present invention typically require a step of breaking the commercially available vegetable chips or previously prepared vegetable chips into fragments having the required size dimensions.

The aspects of vegetable chip spreads that embody the present invention are further described in the following Examples.

### EXAMPLE 1

Preparation of a potato chip spread using commercially available potato chips: 81.5 grams (2.875 oz.) of Lay's® Classic Potato Chips (containing 30 grams of total fat, i.e., 30 grams of oil or about 36.8% oil by weight) were added to a countertop food processor. Corn oil (about 3 teaspoons, i.e., about 15 mL, about 14 grams) and sunflower oil (about 3 teaspoons, i.e., about 15 mL, about 14 grams) were added to the food processor containing the potato chips. The resulting mixture of potato chips, corn oil, and sunflower oil was blended and processed in the food processor to break the potato chips into fragments such that substantially all of the potato chips had no single dimension greater than 1 cm, and to achieve a spreadable mixture of uniform consistency.

### EXAMPLE 2

Preparation of a corn chip spread using commercially available corn chips: 131.1 grams (4.625 oz.) of Fritos® corn chips (which contain 10 grams of total fat per 28 grams; i.e., about 35.7% oil by weight) were added to a countertop food processor. Corn oil (about 5 teaspoons, i.e., about 25 mL, about 23 grams) was added to the food processor containing the corn chips. The resulting mixture of corn chips and corn oil was blended and processed in the food processor to break the corn chips into fragments such that substantially all of the corn chips had no single dimension greater than 1 cm, and to achieve a spreadable mixture of uniform consistency.

### EXAMPLE 3

Preparation of a tortilla chip spread using commercially available tortilla chips: 95.6 grams (3.375 oz.) of Doritos® Nacho Cheese Flavored tortilla chips (containing 8 grams of total fat per 28 grams, i.e., about 28.6% oil by weight) were added to a countertop food processor. Corn oil (about 4 teaspoons, i.e., about 20 mL, about 18 grams) and sunflower oil (about 4 teaspoons, i.e., about 20 mL, about 18 grams) were added to the food processor containing the tortilla chips. The resulting mixture of tortilla chips, corn oil, and sunflower oil was blended and processed in the food processor to break the tortilla chips into fragments such that substantially all of the tortilla chips had no single dimension greater than 1 cm, and to achieve a spreadable mixture of uniform consistency.

### EXAMPLE 4

Preparation of a sour cream and onion potato chip spread using commercially available potato chips: 81.5 grams (2.875 oz.) of Lay's® Sour Cream and Onion Flavored Potato Chips (containing 28 grams of total fat; i.e., 28 grams of oil or about 34.4% oil by weight) were added to a countertop food processor. Corn oil (about 3 teaspoons, i.e., about 15 mL, about 14 grams) and sunflower oil (about 3 teaspoons, i.e., about 15 mL, about 14 grams) were added to the food processor containing the potato chips. The resulting mixture of potato chips, corn oil, and sunflower oil was blended and processed in the food processor to break the potato chips into fragments such that substantially all of the potato chips had no single dimension greater than 1 cm, and to achieve a spreadable mixture of uniform consistency.

### EXAMPLE 5 (Prophetic)

Example 5 describes preparation of a tortilla chip spread using commercially available tortilla chips: 81.5 grams (2.875 oz.) of Doritos® Nacho Cheese Flavored Tortilla Chips (containing 8 grams of total fat per 28 grams, i.e., about 28.6% oil by weight) is added to a countertop food processor. Canola oil (74 mL; 68 grams) is added to the food processor. The resulting mixture of tortilla chips and canola oil is blended and processed in the food processor to break up the tortilla chips into fragments such that substantially all of the tortilla chips have no single dimension greater than 1 cm, and to achieve a spreadable mixture of uniform consistency.

### EXAMPLE 6 (Prophetic)

Example 6 describes preparation of a corn chip spread using commercially available corn chips: 81.5 grams (2.875 oz.) of Fritos® Corn Chips (which contain 10 grams of total fat per 28 grams; i.e., about 35.7% oil by weight) is added to a countertop food processor. Corn oil (74 mL; 68 grams) is added to the food processor. The resulting mixture of corn chips and corn oil is blended and processed in the food processor to break up the corn chips into small fragments, such that substantially all of the corn chips have no single dimension greater than 1 cm, and thereby achieve a spreadable mixture of uniform consistency.

### EXAMPLE 7 (Prophetic)

Example 7 describes preparation of a potato chip spread wherein the potato slices are cooked prior to preparing the spread: 51.5 grams of sliced, uncooked potatoes is added to a deep fryer containing hot canola oil. After the potato slices have been fully cooked, all but 75 mL (69 grams) of the canola oil is decanted from the deep fryer. The remaining mixture of cooked potato slices and canola oil is transferred to a countertop food processor where it is blended and processed to break the cooked potato slices into small fragments, such that substantially all of the cooked potato chips have no single dimension greater than 1 cm, and thereby achieve a spreadable mixture of uniform consistency.

### EXAMPLE 8 (Prophetic)

Example 8 describes preparation of a vegetable chip spread comprising two different types of vegetable chip: 40.75 grams of Lay's® Classic Potato Chips (containing 36.8% total fat by weight, i.e., 36.8% oil by weight) is added to a countertop food processor. 40.75 grams of Doritos® Nacho Cheese Flavored Tortilla Chips (containing 28.6% total fat by weight, i.e., 28.6% oil by weight) is added to the food processor. Canola oil (74 mL, 68 grams) is added to the food processor. The resulting mixture of potato chips, tortilla chips, and canola oil is blended and processed in the food processor to break the potato and tortilla chips into small fragments, such that substantially all of the potato and tortilla chips have no single dimension greater than 1 cm, and thereby achieve a spreadable mixture of uniform consistency.

### EXAMPLE 9 (Prophetic)

Preparation of a potato chip spread using commercially available potato chips: 81.5 grams (2.875 oz.) of cooked potato chips having a total fat content of 25% to 40% by weight (i.e., about 25% to about 40% oil by weight) is added to a countertop food processor. A potato chip having a total fat content of about 36.8% (i.e., containing about 36.8% oil by weight) is Lay's® Classic Potato Chips, which is available in many grocery stores throughout the United States. Canola oil (14.8 mL; 13.6 grams) and sunflower oil (14.8 mL; 13.6 grams) are added to the food processor containing the potato chips. The resulting mixture of potato chips, canola oil, and sunflower oil are blended and processed in the food processor to break the potato chips into fragments such that substantially all of the cooked potato chips have no single dimension greater than 1 cm, and to achieve a spreadable mixture of uniform consistency.

### EXAMPLE 10 (Prophetic)

Preparation of a corn chip spread using commercially available corn chips: 81.5 grams (2.875 oz.) of a corn chip having a total fat content of about 25% to about 40% by weight (i.e., about 25% to about 40% oil by weight) is added to a countertop food processor. A corn chip having a total fat content of about 35.7% by weight (i.e., containing about 35.7% oil by weight) is Fritos® Corn Chips, available in many grocery stores throughout the United States. A corn chip having a total fat content of about 28.6% by weight (i.e., containing about 28.6% oil by weight) is Doritos® Nacho Cheese Flavored Tortilla Chips, available in many grocery stores throughout the United States. Corn oil (74 mL; 68 grams) is added to the food processor. The resulting mixture of corn chips and corn oil is blended and processed in the food processor to break up the corn chips into small fragments, such that substantially all of the corn chips have no single dimension greater than 1 cm, and thereby achieve a spreadable mixture of uniform consistency.

The vegetable chip spreads that embody the present invention are used by applying the vegetable chip spread to a food item to which one wishes to impart the vegetable chip taste. For example, one could use the vegetable chip spread in making a sandwich by applying the spread to one or more slices of bread using a utensil such as a butter knife, and then using the one or more slices of bread to which the spread was applied as an outermost or internal layer of a sandwich.

1. A vegetable chip spread comprising:
cooked vegetable chips, wherein substantially all of said cooked vegetable chips have no single dimension greater than 1 cm in length; and
added oil, wherein the oil content of said vegetable chip spread is from about 40% to about 70%.

2. The vegetable chip spread of claim 1 wherein the oil content of said vegetable chip spread is from about 42% to about 50%.

3. The vegetable chip spread of claim 1 wherein the oil content of said vegetable chip spread is from about 50% to about 60%.

4. The vegetable chip spread of claim 1 wherein the oil content of said vegetable chip spread is from about 45% to about 48%.

5. The vegetable chip spread of claim 1 wherein the oil content of said vegetable chip spread is from about 51% to about 53%.

6. The vegetable chip spread of claim 1 wherein said added oil comprises one or more oils selected from the group consisting of almond oil, avocado oil, canola oil, cashew nut oil, castor oil, chia oil, coconut oil, corn oil, flaxseed oil, melon seed oil, mustardseed oil, olive oil, palm oil, peanut oil, safflower oil, sesame oil, soybean oil, sunflower oil, and vegetable oil.

7. The vegetable chip spread of claim 1 wherein said added oil comprises one or more oils selected from the group consisting of canola oil, corn oil, olive oil, peanut oil, safflower oil, sunflower oil, and vegetable oil.

8. The vegetable chip spread of claim 1 wherein said added oil comprises canola oil.

9. The vegetable chip spread of claim 1 wherein said added oil comprises sunflower oil.

10. The vegetable chip spread of claim 1 wherein said added oil comprises corn oil.

11. The vegetable chip spread of claim 1 wherein said cooked vegetable chips comprise one or more cooked vegetable chips selected from the group consisting of potato chips, corn chips, sweet potato chips, zucchini chips, turnip chips, squash chips, beet chips, eggplant chips, bell pepper chips, yucca, parsnip, taro, batata, and onion chips.

12. The vegetable chip spread of claim 1 wherein said cooked vegetable chips comprise one or more cooked vegetable chips selected from the group consisting of potato chips and corn chips.

13. The vegetable chip spread of claim 1 wherein said cooked vegetable chips are potato chips.

14. The vegetable chip spread of claim 1 wherein said cooked vegetable chips are corn chips.

15. The vegetable chip spread of claim 1 wherein said cooked vegetable chips are potato chips and wherein the oil content of said vegetable chip spread is from about 51% to about 53%.

16. The vegetable chip spread of claim 1 wherein said cooked vegetable chips are corn chips and wherein the oil content of said vegetable chip spread is from about 45% to about 48%.
